(19) United States
(12) Patent Application Publication
(10) Pub. No.: US 2026/0089559 A1
(43) Pub. Date: Mar. 26, 2026

(54) DISCARDED PROTOCOL DATA UNIT INDICATION

(71) Applicant: QUALCOMM Incorporated, San Diego, CA (US)

(72) Inventors: Sherif ELAZZOUNI, San Diego, CA (US); Ozcan OZTURK, San Diego, CA (US); Gavin Bernard HORN, La Jolla, CA (US)

(21) Appl. No.: 18/893,534

(22) Filed: Sep. 23, 2024

(51) Int. Cl. H04W 28/06; H04W 28/02; H04W 80/02

(52) U.S. Cl. CPC H04W 28/06; H04W 28/0268; H04W 80/02

(57) ABSTRACT

Various aspects of the present disclosure generally relate to wireless communication. In some aspects, a user equipment (UE) may receive a control protocol data unit (PDU) configuration. The UE may transmit, in accordance with the control PDU configuration, a control PDU indicating a plurality of discarded PDUs that are associated with respective layer 2 (L2) sublayers and that are associated with a common packet. Numerous other aspects are described.

### FIELD OF THE DISCLOSURE

Aspects of the present disclosure generally relate to wireless communication and specifically relate to techniques, apparatuses, and methods for a discarded protocol data unit indication.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a user plane protocol stack and a control plane protocol stack for a network node and a core network in communication with a UE, in accordance with the present disclosure.

FIG. 5 is a diagram illustrating an example of medium access control (MAC) sublayer redundancies, in accordance with the present disclosure.

FIG. 6 is a diagram illustrating an example associated with signaling for discarded protocol data unit (PDU) indications, in accordance with the present disclosure.

FIG. 7 is a diagram illustrating examples associated with a control PDU field format, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### SUMMARY

Some aspects described herein relate to an apparatus for wireless communication at a user equipment (UE). The apparatus may include one or more memories and one or more processors coupled to the one or more memories. The one or more processors may be configured to cause the UE to receive a control protocol data unit (PDU) configuration. The one or more processors may be configured to cause the UE to transmit, in accordance with the control PDU configuration, a control PDU indicating a plurality of discarded PDUs that are associated with respective layer 2 (L2) sublayers and that are associated with a common packet.

Some aspects described herein relate to an apparatus for wireless communication at a network node. The apparatus may include one or more memories and one or more processors coupled to the one or more memories. The one or more processors may be configured to cause the network node to transmit a control PDU configuration. The one or more processors may be configured to cause the network node to receive, in accordance with the control PDU configuration, a control PDU indicating a plurality of discarded PDUs that are associated with respective L2 sublayers and that are associated with a common packet.

Some aspects described herein relate to a method of wireless communication performed by a UE. The method may include receiving a control PDU configuration. The method may include transmitting, in accordance with the control PDU configuration, a control PDU indicating a plurality of discarded PDUs that are associated with respective L2 sublayers and that are associated with a common packet.

Some aspects described herein relate to a method of wireless communication performed by a network node. The method may include transmitting a control PDU configuration. The method may include receiving, in accordance with the control PDU configuration, a control PDU indicating a plurality of discarded PDUs that are associated with respective L2 sublayers and that are associated with a common packet.

Some aspects described herein relate to a non-transitory computer-readable medium that stores a set of instructions for wireless communication by a UE. The set of instructions, when executed by one or more processors of the UE, may cause the UE to receive a control PDU configuration. The set of instructions, when executed by one or more processors of the UE, may cause the UE to transmit, in accordance with the control PDU configuration, a control PDU indicating a plurality of discarded PDUs that are associated with L2 sublayers and that are associated with a common packet.

Some aspects described herein relate to a non-transitory computer-readable medium that stores a set of instructions for wireless communication by a network node. The set of instructions, when executed by one or more processors of the network node, may cause the network node to transmit a control PDU configuration. The set of instructions, when executed by one or more processors of the network node, may cause the network node to receive, in accordance with the control PDU configuration, a control PDU indicating a plurality of discarded PDUs that are associated with respective L2 sublayers and that are associated with a common packet.

Some aspects described herein relate to an apparatus for wireless communication. The apparatus may include means for receiving a control PDU configuration. The apparatus may include means for transmitting, in accordance with the control PDU configuration, a control PDU indicating a plurality of discarded PDUs that are associated with respective L2 sublayers and that are associated with a common packet.

Some aspects described herein relate to an apparatus for wireless communication. The apparatus may include means for transmitting a PDU configuration. The apparatus may include means for receiving, in accordance with the control PDU configuration, a control PDU indicating a plurality of discarded PDUs that are associated with respective L2 sublayers and that are associated with a common packet.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Different levels of abstraction for wireless communication may correspond to respective layers. For example, the layers may include a Layer 1 (L1) (also referred to as a physical (PHY) layer), a Layer 2 (L2), a Layer 3 (L3), and so forth. In some cases, a layer may be split into sublayers. For example, L2 may include a packet data convergence protocol (PDCP) sublayer, a radio link control (RLC) sublayer, and a medium access control (MAC) sublayer, or the like. The PDCP sublayer may handle various services and functions, including sequence numbering, header compression and decompression, transfer of user data, reordering and duplicate detection, PDCP protocol data unit (PDU) routing, retransmission of PDCP service data units (SDUs), ciphering and deciphering, PDCP SDU discard, PDCP re-establishment and data recovery, duplication of PDCP PDUs, or the like. Additionally, or alternatively, the RLC sublayer may handle various services and functions, including transfer of upper layer PDUs to the MAC sublayer or the PHY layer, sequence numbering independent of PDCP sequence numbering, error correction, segmentation and re-segmentation, reassembly of an SDU, RLC SDU discard, RLC re-establishment, or the like. Additionally, or alternatively, the MAC sublayer may handle various services and functions, including mapping between logical channels and transport channels, multiplexing/demultiplexing of MAC SDUs, scheduling information reporting, error correction, priority handling between UEs, priority handling between logical channels of one UE, padding or the like.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In some examples, a transmitter may indicate, to the receiver, that the transmitter has discarded a PDCP PDU via a PDCP discard indication, that the transmitter has discarded an RLC PDU via an RLC discard indication, or that the transmitter has discarded a MAC PDU via a MAC discard indication. Thus, L2 sublayers may have respective PDU discard indications, including the PDCP discard indication, the RLC discard indication, and the MAC discard indication.

These respective PDU discard indications may create PDU discard conflicts between different L2 sublayers. A PDU discard conflict may arise when certain L2 sublayers may have discarded a PDU associated with a given packet and other L2 sublayers have not discarded a PDU associated with the given packet. Such conflicts may be caused by different sublayers being associated with different latencies: for example, the MAC sublayer may be associated with a lowest latency, the RLC sublayer may be associated with a middle latency, and the PDCP sublayer may be associated with a highest latency. PDU discard conflicts can consume excessive processing resources, memory resources, or the like. For example, as a result of a PDU discard conflict, the PDCP sublayer may consume processing and/or memory resources to perform reordering. Additionally, or alternatively, using separate PDU discard indications can consume excessive overhead.

Various aspects relate generally to a joint discarded PDU indication. Some aspects more specifically relate to an indication that multiple PDUs of respective L2 sublayers have been discarded. For example, the joint discarded PDU indication may indicate that a PDCP PDU, an RLC PDU, and/or a MAC PDU have been discarded. In some aspects, a user equipment (UE) may transmit the joint discarded PDU indication to a network node in the form of a MAC control element (MAC-CE).

Particular aspects of the subject matter described in this disclosure can be implemented to realize one or more of the following potential advantages. In some examples, by providing the joint discarded PDU indication, the described techniques can be used to mitigate conflicts between different L2 sublayers. For example, instead of multiple PDU discard indications indicating respective PDU discards, the joint discarded PDU indication may indicate the plurality of discarded PDUs. As a result, the joint discarded PDU indication may conserve processing resources, memory resources, overhead, or the like. The joint discarded PDU indication being a MAC-CE may help to improve latency.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

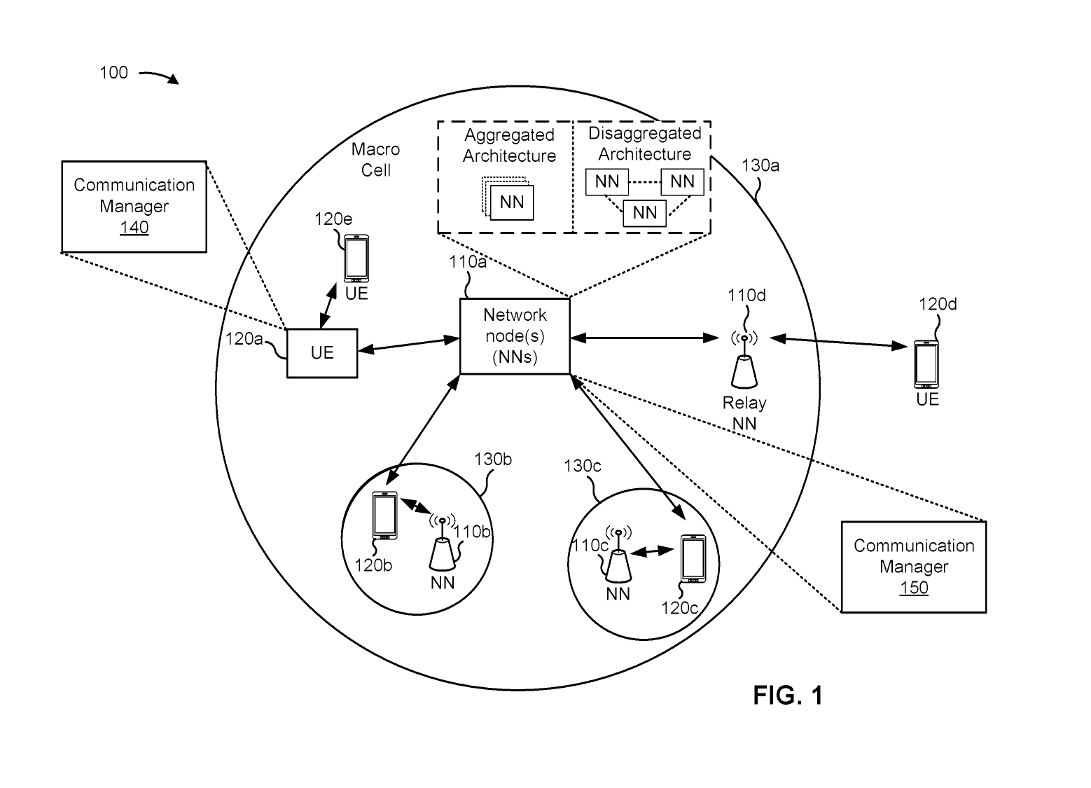

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, PDCP functions, and/or service data adaptation protocol (SDAP) functions, among other examples. A DU may host one or more of a RLC layer, a MAC layer, and/or one or more higher PHY layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c.Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a control PDU configuration; and transmit, in accordance with the control PDU configuration, a control PDU indicating a plurality of discarded PDUs that are associated with respective L2 sublayers and that are associated with a common packet. Additionally, or alternatively, the communication manager 140 may perform one or more other operations described herein.

In some aspects, the network node 110 may include a communication manager 150. As described in more detail elsewhere herein, the communication manager 150 may transmit a PDU configuration; and receive, in accordance with the control PDU configuration, a control PDU indicating a plurality of discarded PDUs that are associated with respective L2 sublayers and that are associated with a common packet. Additionally, or alternatively, the communication manager 150 may perform one or more other operations described herein.

As indicated above, FIG. 1 is provided as an example. Other examples may differ from what is described with regard to FIG. 1.

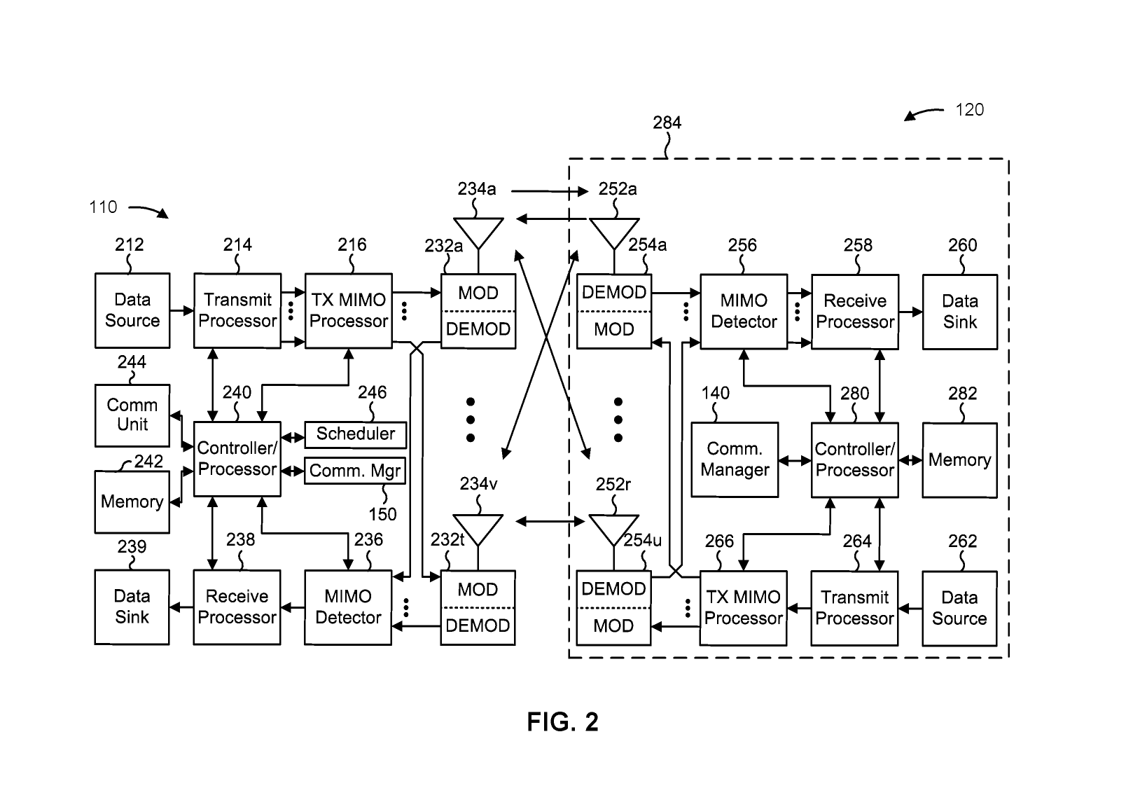

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t ≥ 1), a set of antennas 234 (shown as 234a through 234v, where v ≥ 1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC-CE communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r ≥ 1), a set of modems 254 (shown as modems 254a through 254u, where u ≥ 1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

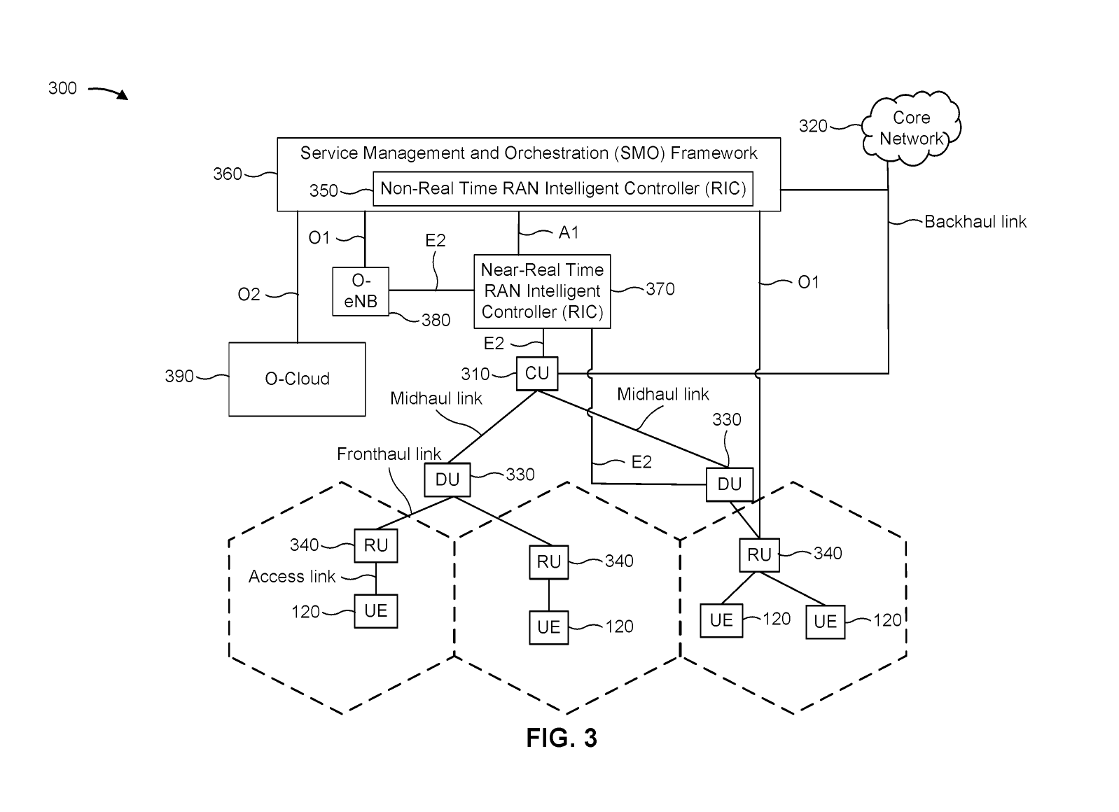

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

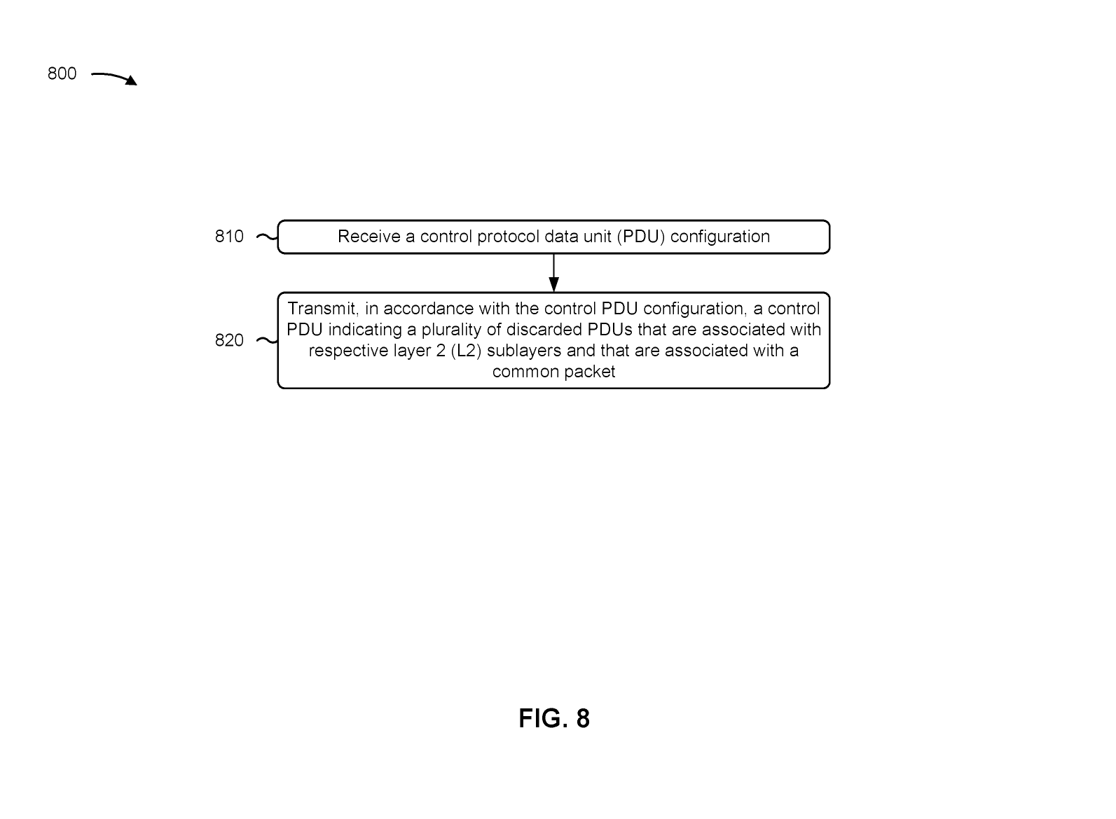

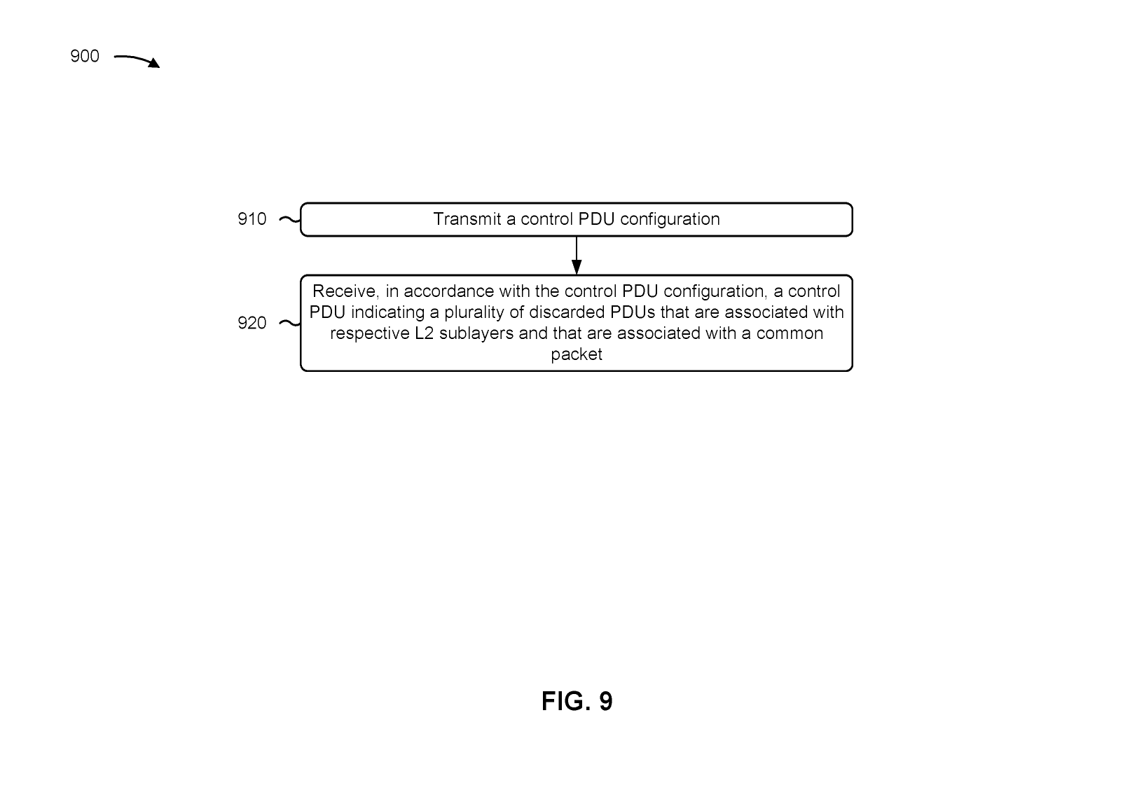

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with a discarded PDU indication, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, the UE 120 includes means for receiving a control PDU configuration; and/or means for transmitting, in accordance with the control PDU configuration, a control PDU indicating a plurality of discarded PDUs that are associated with respective L2 sublayers and that are associated with a common packet. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a control PDU configuration; and/or means for receiving, in accordance with the control PDU configuration, a control PDU indicating a plurality of discarded PDUs that are associated with respective L2 sublayers and that are associated with a common packet. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

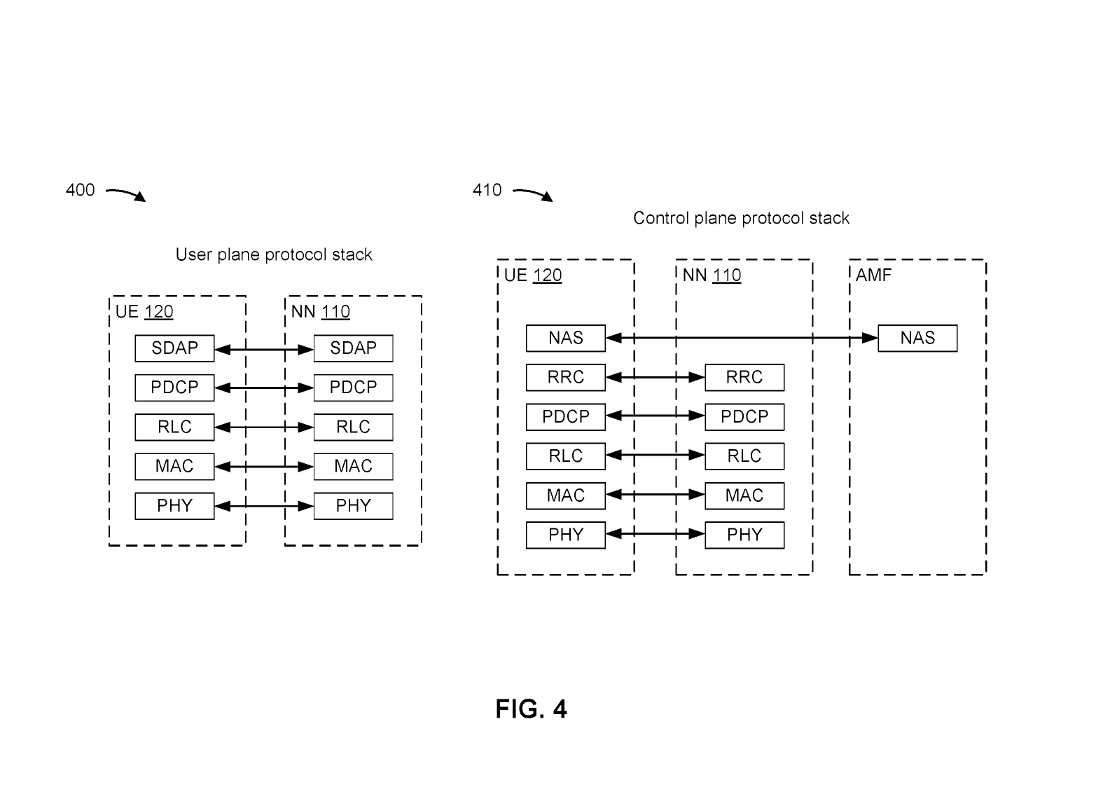

FIG. 4 is a diagram illustrating an example of a user plane protocol stack 400 and a control plane protocol stack 410 for a network node 110 and a core network in communication with a UE 120, in accordance with the present disclosure. On the user plane, the UE 120 and the network node 110 may include respective PHY layers, MAC layers, RLC layers, PDCP layers, and SDAP layers.

A user plane function may handle transport of user data between the UE 120 and the network node 110. On the control plane, the UE 120 and the network node 110 may include respective RRC layers. Furthermore, the UE 120 may include a non-access stratum (NAS) layer in communication with a NAS layer of an access and management mobility function (AMF). The AMF may be associated with a core network associated with the network node 110, such as a 5G core network (5GC) or a next-generation radio access network (NG-RAN). A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP, PDCP, RLC, and MAC layer may be referred to as higher than the PHY layer and lower than the RRC layer. An application (APP) layer, not shown in FIG. 4, may be higher than the SDAP, PDCP, RLC, and MAC layer. In some cases, an entity may handle the services and functions of a given layer (for example, a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (for example, handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as L3.

The SDAP layer, PDCP layer, RLC layer, and MAC layer may be collectively referred to as L2. Thus, in some cases, the SDAP, PDCP, RLC, and MAC layers are referred to as sublayers of L2. On the transmitting side (for example, if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some examples, the RRC or NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP PDU routing (in case of split bearers), retransmission of PDCP SDUs, ciphering and deciphering, PDCP SDU discard (for example, in accordance with a timer), PDCP re-establishment and data recovery for RLC acknowledged mode (RLC-AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs. In some examples, a transmitter may inform a receiver of a sequence numbering gap (or missing sequence numbers) in the PDCP layer.

The PDCP layer may provide data, in the form of PDCP PDUs, to the RLC layer via RLC channels. The RLC layer may handle transfer of upper layer PDUs to the MAC or PHY layers, sequence numbering independent of PDCP sequence numbering, error correction via automatic repeat request (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from TBs delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal. The PHY layer is frequently referred to as L1.

On the receiving side (for example, if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 4 is provided as an example. Other examples may differ from what is described with regard to FIG. 4.

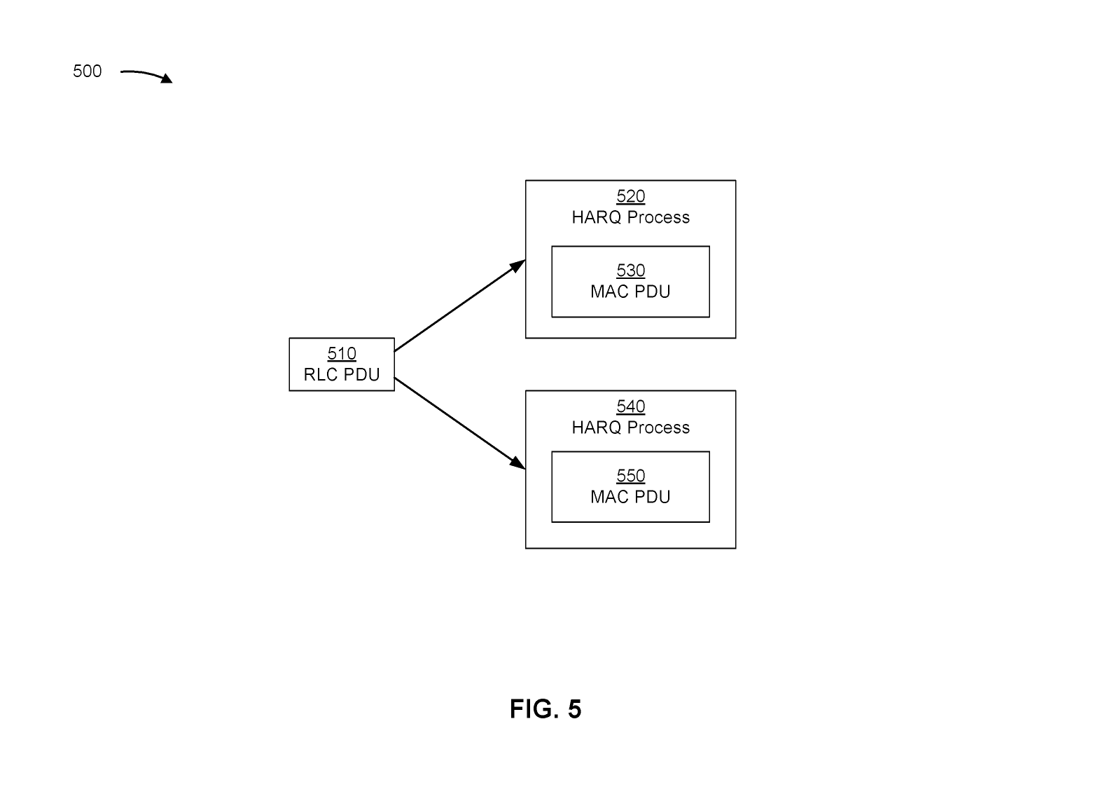

FIG. 5 is a diagram illustrating an example 500 of MAC sublayer redundancies, in accordance with the present disclosure.

In some examples, a transmitter (e.g., a UE 120) may indicate, to a receiver (e.g., a network node 110), that the transmitter has discarded a PDCP PDU (“PDCP discard indication”). The transmitter and the receiver may include respective PDCP entities that exchange the PDCP discard indication. The PDCP discard indication may enable the transmitter to inform the receiver not to wait for a given sequence number for reordering of PDCP PDUs at the receiver. The transmitter may transmit the PDCP discard indication responsive to a timer expiry, congestion, or the like. In some examples, the PDCP discard indication may enable the transmitter to discard PDCP PDUs for low-importance traffic. Thus, the PDCP discard indication may help to decongest network traffic.

In some examples, a first wireless communication device (e.g., a transmitter or a receiver) may indicate, to a second wireless communication device (e.g., a transmitter or a receiver), that the first wireless communication device has discarded an RLC PDU (“RLC discard indication”). The first wireless communication device and the second wireless communication device may include respective RLC entities that exchange the PDCP discard indication. The RLC discard indication may help to avoid unnecessary retransmission (e.g., when a packet delay budget (PDB) expires), such as in XR scenarios. In cases where the first wireless communication device is a transmitter (e.g., in a transmitter-initiated approach in an acknowledge mode (AM)), the transmitter-side RLC entity may notify the receiver-side RLC entity of obsolete SDUs (e.g., using the RLC discard indication). The transmitter may stop retransmitting the obsolete SDUs, and the receiver may update state variables according to the information received from the transmitter. In cases where the first wireless communication device is a receiver (e.g., in a receiver-initiated approach in an AM), the receiver-side RLC entity may determine that one or more SDUs should be abandoned, and the receiver may indicate the abandoned SDUs (e.g., using the RLC discard indication). In some examples, the transmitter may process one or more status reports that are transmitted by the receiver. Thus, the RLC discard indication may enable the transmitter to drop an RLC PDU (and/or an RLC SDU) due to latency exceeding a PDB and/or may enable the receiver to move (e.g., advance) a transmitting window.

In some examples (e.g., in XR scenarios), the transmitter may retransmit PDUs responsive to an enhanced status report, enhanced polling, or the like. Additionally, or alternatively, the transmitter may autonomously retransmit PDUs responsive to one or more triggers (e.g., a lack of a status report for a given time period, a given quantity of HARQ failures, or the like). The retransmission may be autonomous in that the retransmission is not responsive to a status report. For example, the transmitter may perform autonomous retransmissions at the RLC sublayer responsive to a timer expiry, without receiving a status report. UE autonomous retransmission may help to enable the transmitter to achieve timely retransmissions on the RLC sublayer for XR traffic; however, such autonomous retransmissions may also impact network capacity, such as by leading to duplicate transmissions at the MAC sublayer.

Example 500 illustrates how autonomous retransmissions can cause redundancies at the MAC sublayer. In example 500, the transmitter may transmit a communication based at least in part on an RLC PDU 510. The transmitter (e.g., the transmitter-side RLC entity) may use a first HARQ process 520 to transmit a MAC PDU 530. For example, the MAC PDU 530 may be an initial MAC PDU that carries the RLC PDU 510. The first HARQ process 520 may be associated with HARQ identifier (ID) 0. In some examples, the transmitter may transmit the MAC PDU 530 via a first component carrier.

After one or more triggers have occurred (e.g., a given amount of time has elapsed, a given quantity of HARQ retransmissions have been attempted, a timer has expired before a new HARQ scheduled transmission, or the like), the transmitter may perform a proactive MAC PDU retransmission. For example, the transmitter (e.g., the transmitter-side RLC entity) may use a second HARQ process 540 (e.g., associated with HARQ ID 1) to transmit a MAC PDU 550. For example, the MAC PDU 550 may be a retransmitted MAC PDU that carries the RLC PDU 510. For example, the transmitter may transmit the MAC PDU 550 via a second component carrier and/or with a predicted best redundancy version (RV). Thus, the receiver may schedule transmissions and retransmissions for both the HARQ processes 520 and 540.

In some cases, the transmitter-side RLC entity may initiate the MAC PDU retransmission at the HARQ process 540 too early (e.g., while the MAC PDU 530 is still in the process of HARQ retransmission). For example, the MAC PDU 530 may be transmitted successfully after the MAC PDU retransmission is established. Additionally, or alternatively, the MAC PDU 550 may be transmitted successfully, and the HARQ process 520 may continue to perform HARQ retransmissions. As a result, at least one of the HARQ processes 520 or 540 may be redundant. For example, because the receiver may not obtain information indicating that the MAC PDU 530 and the MAC PDU 550 carry the same RLC PDU 510, the HARQ process 520 may consume resources to transmit the MAC PDU 530 after the MAC PDU 550 has been transmitted successfully, or the HARQ process 540 may consume resources to transmit the MAC PDU 550 after the MAC PDU 530 has been transmitted successfully. In this sense, a goal associated with the autonomous retransmission (e.g., achieving timely transmissions at the RLC sublayer) may conflict with a goal associated with the PDCP discard indication and/or the RLC discard indication (e.g., enabling the transmitter to discard PDCP PDUs and/or RLC PDUs at L2 and thereby limit impact on network capacity).

In some examples, the transmitter may indicate, to the receiver, that the transmitter has discarded a MAC PDU (“MAC discard indication”). The transmitter and the receiver may include respective MAC entities that exchange the MAC discard indication. In some examples, the MAC discard indication may enable the transmitter to discard MAC PDUs, such as the MAC PDU 530 and/or the MAC PDU 550. For example, the MAC discard indication may inform the receiver that a payload (e.g., an RLC PDU) associated with a given HARQ ID has been discarded or successfully transmitted using another component carrier and/or HARQ process (e.g., due to a fast or predictive RLC PDU retransmission). As a result, the MAC discard indication may help to reduce a loss in network capacity by enabling the transmitter to discard one of the MAC PDUs 530 or 550 after the other of the MAC PDUs 530 or 550 was transmitted successfully. Additionally, or alternatively, the MAC discard indication may be used to discard MAC PDUs responsive to a timer expiry or other triggers.

Thus, L2 sublayers may have respective PDU discard indications, including the PDCP discard indication, the RLC discard indication, and the MAC discard indication. These respective PDU discard indications may lead to PDU discard conflicts between different L2 sublayers. A PDU discard conflict may arise when certain L2 sublayers have discarded a PDU associated with a given packet and other L2 sublayers have not discarded a PDU associated with the given packet. Such conflicts may be caused by different sublayers being associated with different latencies: for example, the MAC sublayer may be associated with a lowest latency, the RLC sublayer may be associated with a middle latency, and the PDCP sublayer may be associated with a highest latency. PDU discard conflicts can consume excessive processing resources, memory resources, or the like. For example, as a result of a PDU discard conflict, the PDCP sublayer may consume processing and/or memory resources to perform reordering. Additionally, or alternatively, using separate PDU discard indications can consume excessive overhead.

As indicated above, FIG. 5 is provided as an example. Other examples may differ from what is described with regard to FIG. 5.

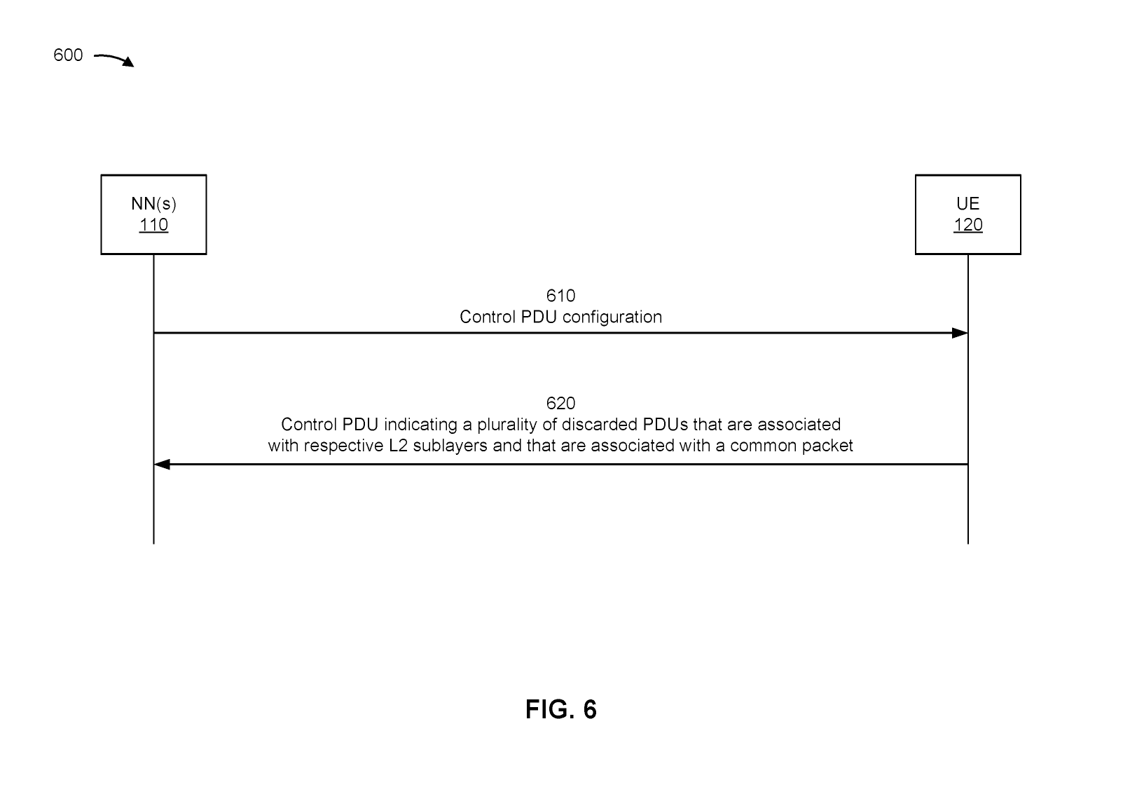

FIG. 6 is a diagram illustrating an example 600 associated with signaling for discarded PDU indications, in accordance with the present disclosure. As shown in FIG. 6, a network node 110 and a UE 120 may communicate with one another.

As shown by reference number 610, the network node 110 may transmit, and the UE may receive, a control PDU configuration. In some examples, the control PDU configuration may enable the UE 120 to transmit a control PDU, as discussed in connection with reference number 620. Additionally, or alternatively, the control PDU configuration may configure when the UE 120 is permitted to transmit the control PDU. For example, the control PDU configuration may configure a prohibit timer such that the UE 120 is prohibited from transmitting the control PDU before the prohibit timer expires.

As shown by reference number 620, the UE 120 may transmit, and the network node 110 may receive, in accordance with the control PDU configuration, a control PDU. For example, the UE 120 may transmit the control PDU based at least in part on the control PDU configuration enabling the UE 120 to transmit the control PDU and/or the control PDU configuration configuring when the UE 120 is permitted to transmit the control PDU. In some aspects, the control PDU may indicate a plurality of discarded PDUs that are associated with respective L2 sublayers and that are associated with a common packet. The plurality of discarded PDUs may be associated with the respective L2 sublayers in that the plurality of discarded PDUs may belong to the respective L2 sublayers, such as the L2 sublayers discussed above in connection with FIG. 4. The plurality of discarded PDUs may be associated with the common packet in that each of the discarded PDUs may correspond to (e.g., carry data and/or control information for) the common packet. For example, the control PDU may jointly indicate that each of the discarded PDUs of the common packet (e.g., a single packet) have been discarded. In this sense, the control PDU may combine multiple PDU discard indications, as discussed above in connection with FIG. 5.

In some aspects, the control PDU may be a MAC control PDU. For example, the MAC control PDU may be a MAC-CE that is transmitted from a MAC entity on the UE 120 to a MAC entity on the network node 110. Additionally, or alternatively, the control PDU may be an RLC control PDU that is transmitted from an RLC entity on the UE 120 to an RLC entity on the network node 110. Additionally, or alternatively, the control PDU may be an RLC control PDU that is transmitted from a PDCP entity on the UE 120 to a PDCP entity on the network node 110.

In some aspects, one of the respective L2 sublayers may be a PDCP sublayer. For example, the control PDU may indicate a plurality of discarded PDUs, at least one of which is associated with the PDCP sublayer. For example, at least one of the discarded PDUs may be a discarded PDCP PDU.

In some aspects (e.g., where one of the respective L2 sublayers is a PDCP sublayer), the control PDU may indicate a PDCP sequence number of the discarded PDU associated with the PDCP sublayer. For example, the PDCP sequence number may be a sequence number of the discarded PDU at the PDCP sublayer.

In some aspects, one of the respective L2 sublayers may be an RLC sublayer. For example, the control PDU may indicate a plurality of discarded PDUs, at least one of which is associated with the RLC sublayer. For example, at least one of the discarded PDUs may be a discarded RLC PDU.

In some aspects (e.g., where one of the respective L2 sublayers is an RLC sublayer), the control PDU may indicate an RLC sequence number of the discarded PDU associated with the RLC sublayer. For example, the RLC sequence number may be a sequence number of a discarded PDU at the RLC sublayer. In some examples, the control PDU may also indicate a discarded segment of the discarded PDU.

In some aspects, one of the respective L2 sublayers may be a MAC sublayer. For example, the control PDU may indicate a plurality of discarded PDUs, at least one of which is associated with the MAC sublayer. For example, at least one of the discarded PDUs may be a discarded MAC PDU.

In some aspects (e.g., where one of the respective L2 sublayers is a MAC sublayer), the control PDU may indicate one or more of a component carrier (CC) identifier or a hybrid automatic repeat request (HARQ) identifier of the discarded PDU associated with the MAC sublayer. In some examples, the control PDU may indicate multiple CC identifiers (e.g., in dual connectivity use cases). The CC identifier and the HARQ identifier may be examples of MAC parameters. In some examples, the control PDU may indicate one or more other MAC parameters.

In some aspects, the control PDU may indicate one or more of a logical channel (LCH) identifier associated with one or more of the plurality of discarded PDUs, a compressed header associated with one or more of the plurality of discarded PDUs, a bearer identifier associated with one or more of the plurality of discarded PDUs, or a QoS flow identifier associated with one or more of the plurality of discarded PDUs. The LCH identifier may be associated with one or more of the plurality of discarded PDUs in that the LCH identifier may indicate which LCH the one or more of the plurality of discarded PDUs belong to. The compressed header may be associated with one or more of the plurality of discarded PDUs in that the compressed header may be a compressed header (e.g., compressed using robust header compression (ROHC) and/or Ethernet header compression (EHC)) of the one or more of the plurality of discarded PDUs. The bearer identifier may be associated with one or more of the plurality of discarded PDUs in that the bearer identifier may indicate a bearer of the one or more of the plurality of discarded PDUs that is served by an LCH of the one or more of the plurality of discarded PDUs. The QoS flow identifier may be associated with one or more of the plurality of discarded PDUs in that the QoS flow identifier may indicate a QoS flow identifier of the one or more of the plurality of discarded PDUs. The control PDU may indicate one or more of the LCH identifier, the compressed header, the bearer identifier, or the QoS flow identifier in one or more fields.

In some aspects, the control PDU may indicate a first plurality of discarded PDUs associated with first respective L2 sublayers and a first common packet, and the control PDU may further indicate at least one second plurality of discarded PDUs that are associated with second respective L2 sublayers and that are associated with a second common packet that is different than the first common packet. Thus, the control PDU may indicate the first plurality of discarded PDUs and the at least one second plurality of discarded PDUs, which may be referred to as “multiple L2 discard,” “multiple L2 discard indication,” “multiple PDU discard,” or “multiple SDU/PDU discard.” In some examples, the control PDU may indicate only the first plurality of discarded PDUs, which may be referred to as “single L2 discard,” “single L2 discard indication,” “single PDU discard,” or “single SDU/PDU discard.”

In some aspects (e.g., where the control PDU indicates the first plurality of discarded PDUs and the at least one second plurality of discarded PDUs), the control PDU may indicate the at least one second plurality of discarded PDUs relative to the first plurality of discarded PDUs. In some examples, the control PDU may indicate a difference (or “delta”) between a PDCP sequence number of the at least one second plurality of discarded PDUs and a PDCP sequence number of the first plurality of discarded PDUs, a difference between an RLC sequence number of the at least one second plurality of discarded PDUs and an RLC sequence number of the first plurality of discarded PDUs, a difference between a HARQ identifier of the at least one second plurality of discarded PDUs and a HARQ identifier of the first plurality of discarded PDUs, or the like. For example, if the control PDU indicates that the PDCP sequence number, RLC sequence number, and HARQ identifier for the first plurality of discarded PDUs are 10, 10, and 0, respectively, and if the PDCP sequence number, RLC sequence number, and HARQ identifier for the at least one second plurality of discarded PDUs are 11, 11, and 1, respectively, then the control PDU may indicate, for the PDCP sequence number, RLC sequence number, and HARQ identifier for the at least one second plurality of discarded PDUs, 1, 1, and 1, respectively. In some examples, the control PDU may indicate a range between the first plurality of discarded PDUs and the at least one second plurality of discarded PDUs. For example, the control PDU may indicate a start and an end of a range of PDCP sequence numbers, a start and an end of a range of RLC sequence numbers, a start and an end of a range of HARQ identifiers (e.g., HARQ identifier 0, HARQ identifier 1, …, HARQ identifier 15). In some examples, the control PDU may indicate multiple pluralities of discarded PDUs relative to the first plurality of discarded PDUs (e.g., each plurality of discarded PDUs associated with a given common packet may be indicated relative to the first plurality of discarded PDUs).

In some aspects, the control PDU may indicate a discard cause value associated with one or more of the plurality of discarded PDUs. The discard cause value may be associated with one or more of the plurality of discarded PDUs in that the discard cause value may indicate a discard cause for the one or more of the plurality of discarded PDUs. For example, the discard cause may be a reason (e.g., a “discard reason”) why the one or more of the plurality of discarded PDUs were discarded. In some examples, the discard cause value may be a bit encoding (e.g., “000”) that indicates a given discard cause.

In some aspects (e.g., where the control PDU indicates the discard cause value), the discard cause value may be associated with one or more of a delay bound expiry, a successful transmission associated with a redundant HARQ process or CC, a PDU set importance (PSI), or a redundant encoded PDU associated with forward error correction (FEC). The discard cause value may be associated with the delay bound expiry (e.g., a packet delay budget expiry) in that the discard cause value may indicate that the discard cause is the delay bound expiry. The successful transmission may be associated with the redundant HARQ process or CC in that the successful transmission may have occurred using the redundant HARQ process or CC (e.g., in a dual connectivity use case). The discard cause value may be associated with the successful transmission in that the discard cause value may indicate that the discard cause is the successful transmission. The discard cause value may be associated with the PSI in that the discard cause value may indicate that the discard cause is the PSI (e.g., congestion and/or low priority). The redundant encoded PDU may be associated with the FEC in that the redundant encoded PDU may be encoded using the FEC. The discard cause value may be associated with the redundant encoded PDU in that the discard cause value may indicate that the discard cause is the redundant encoded PDU (e.g., based at least in part on a PSI, the redundant encoded PDU may enable successful decoding without the one or more of the plurality of discarded PDUs).

In some aspects, the control PDU configuration may indicate a PDCP sequence number gap signaling mechanism. The PDCP sequence number gap signaling mechanism may be a mechanism that the UE uses to signal a PDCP sequence number gap. In some examples, the PDCP sequence number gap signaling mechanism may enable the UE 120 to indicate the PDCP sequence number gap to a CU of the network node 110 (e.g., the PDCP sequence number gap may be transparent to a DU of the network node 110). For example, the UE 120 may indicate the PDCP sequence number gap to the CU in cases where the UE 120 indicates only a PDCP sequence number gap.

In some aspects (e.g., where the control PDU configuration indicates the PDCP sequence number gap signaling mechanism), the PDCP sequence number gap signaling mechanism may be associated with an F1 interface. The PDCP sequence number gap signaling mechanism may be associated with the F1 interface in that the F1 interface may carry an indication of the PDCP sequence number gap (e.g., in the control PDU) from the DU to the CU, and/or from the CU to one or more other DUs (e.g., the CU may propagate the indication of the PDCP sequence number gap to the one or more other DUs, such as in cases involving dual connectivity). For example, the PDCP sequence number gap signaling mechanism may be associated with the F1 interface in cases involving fast RLC transmissions and/or RLC discard.

As indicated above, FIG. 6 is provided as an example. Other examples may differ from what is described with respect to FIG. 6.

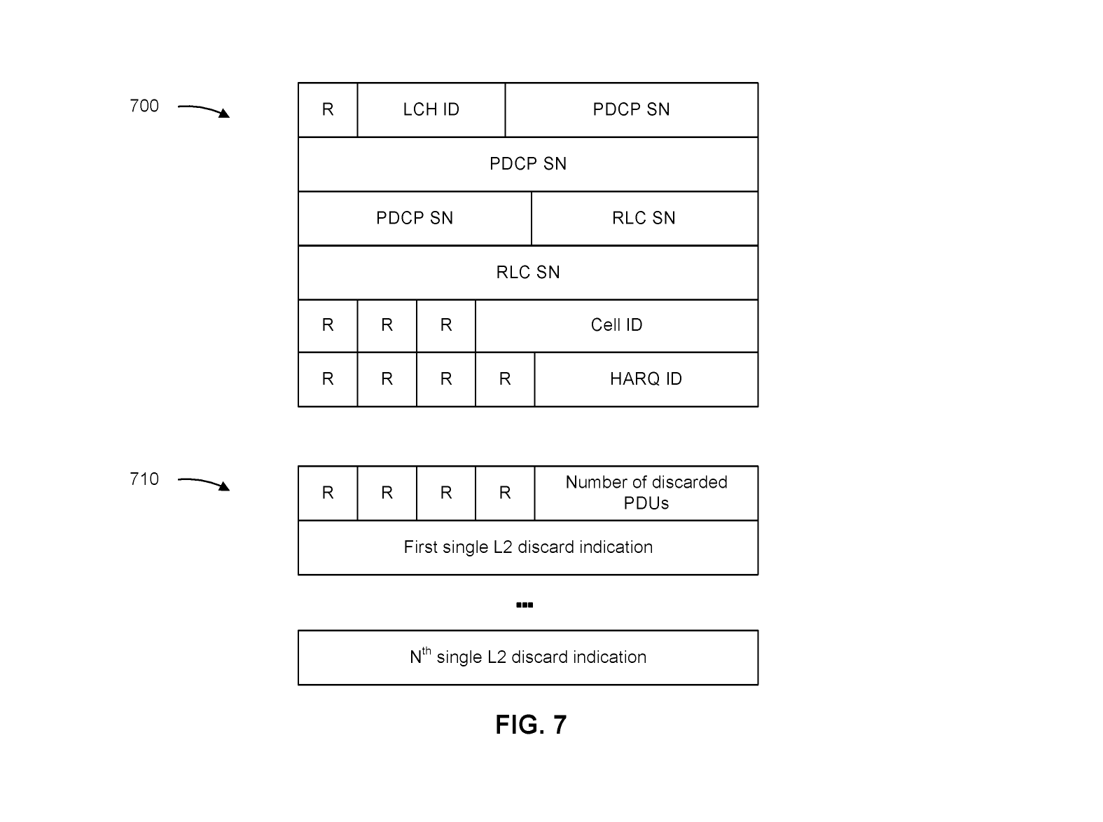

FIG. 7 is a diagram illustrating examples 700 and 710 associated with a control PDU field format, in accordance with the present disclosure.

Example 700 shows a field format for a single L2 discard indication. The field format includes an LCH identifier field (“LCH ID”), a PDCP sequence number field (“PDCP SN”), an RLC sequence number field (“RLC SN”), a CC identifier field (“cell ID”), and a HARQ identifier field (“HARQ ID”). The field format also includes various reserved fields (“R”).

Example 710 shows a field format for a multiple L2 discard indication. A first byte of the field format includes various reserved fields (“R”) and a discarded PDU quantity field that indicates a quantity of discarded PDUs (or SDUs). One or more additional bytes of the field format may include respective single L2 discard indications. For example, each of the single L2 discard indications may follow the field format discussed above in connection with example 700. In some examples, the quantity of discarded PDUs indicated in the discarded PDU quantity field may be equal to a quantity of single L2 discard indications in the multiple L2 discard indication.

As indicated above, FIG. 7 is provided as an example. Other examples may differ from what is described with respect to FIG. 7.

Transmitting the control PDU indicating the plurality of discarded PDUs may help to mitigate conflicts between different L2 sublayers. For example, instead of multiple PDU discard indications indicating respective PDU discards, the control PDU may indicate the plurality of discarded PDUs jointly. As a result, the control PDU indicating the plurality of discarded PDUs may conserve processing resources, memory resources, overhead, or the like. Also, the control PDU being a MAC control PDU may help to improve latency.

The control PDU indicating one or more of the CC identifier or the HARQ identifier of the discarded PDU associated with the MAC sublayer may enable the network node 110 to flush an unsuccessful HARQ buffer and/or stop further retransmissions (e.g., in cases involving proactive RLC retransmission).

The control PDU indicating the LCH identifier associated with one or more of the plurality of discarded PDUs may enable the network node 110 to identify which LCH the discarded PDU belongs to in order to map the sequence number accordingly. The control PDU indicating the compressed header associated with one or more of the plurality of discarded PDUs may help to ensure continuity between headers (e.g., ROHC/EHC continuity) by preventing loss in PDCP, ROHC/EHC, and/or context. The control PDU indicating the bearer identifier associated with one or more of the plurality of discarded PDUs may enable the network node 110 to identify which bearer is associated with one or more of the plurality of discarded PDUs (e.g., in cases where the LCH of the one or more of the plurality of discarded PDUs serves more than a single bearer). The control PDU indicating the QoS flow identifier associated with one or more of the plurality of discarded PDUs may help the network node 110 to perform reordering optimizations.

The control PDU indicating the at least one second plurality of discarded PDUs relative to the first plurality of discarded PDUs may help to efficiently encode the control PDU and, thus, reduce overhead of the control PDU. For example, the control PDU may indicate a relative PDCP sequence number and/or a relative RLC sequence number for the at least one second plurality of discarded PDUs, instead of indicating a full PDCP sequence number and/or a full RLC sequence number.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with discarded PDU indication.

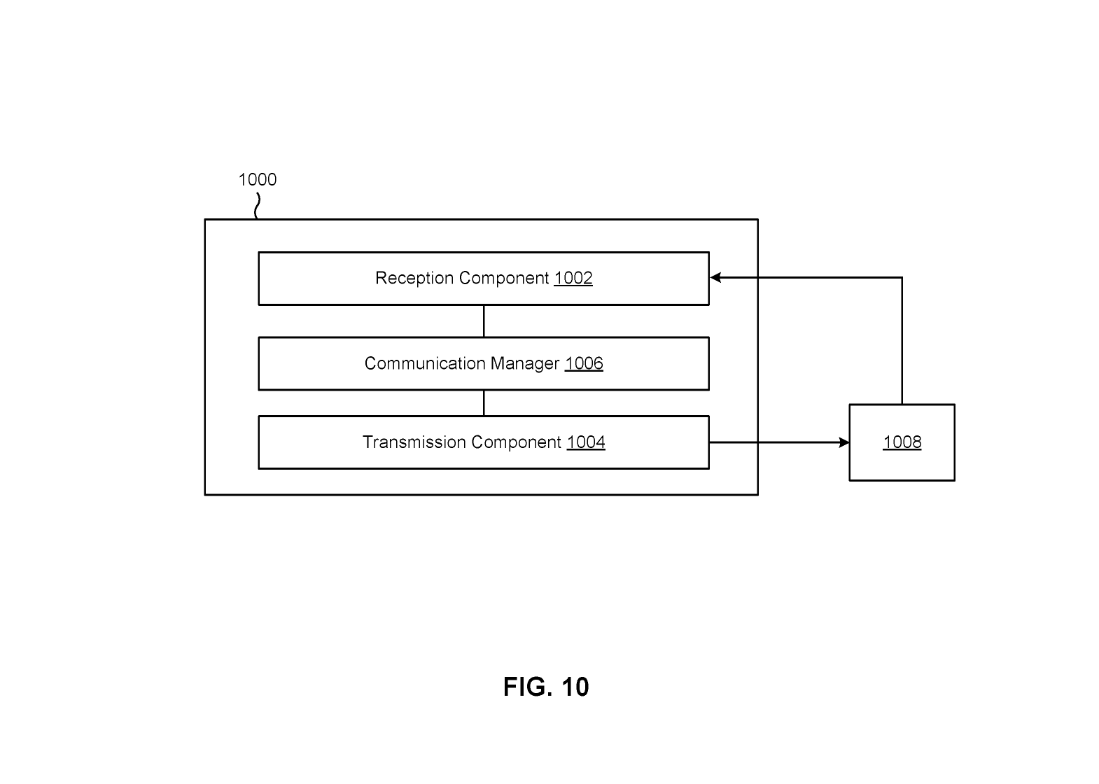

As shown in FIG. 8, in some aspects, process 800 may include receiving a control PDU configuration (block 810). For example, the UE (e.g., using reception component 1002 and/or communication manager 1006, depicted in FIG. 10) may receive a control PDU configuration, as described above. In some aspects, the control PDU configuration may configure the UE to transmit the control PDU and/or when the UE is permitted to transmit the control PDU, as discussed above in connection with reference number 610 (FIG. 6).

As further shown in FIG. 8, in some aspects, process 800 may include transmitting, in accordance with the control PDU configuration, a control PDU indicating a plurality of discarded PDUs that are associated with respective L2 sublayers and that are associated with a common packet (block 820). For example, the UE (e.g., using transmission component 1004 and/or communication manager 1006, depicted in FIG. 10) may transmit, in accordance with the control PDU configuration, a control PDU indicating a plurality of discarded PDUs that are associated with respective L2 sublayers and that are associated with a common packet, as described above. In some aspects, the UE may transmit the control PDU based at least in part on the control PDU configuration enabling the UE to transmit the control PDU and/or the control PDU configuration configuring when the UE is permitted to transmit the control PDU, as discussed above in connection with reference number 620 (FIG. 6).

Process 800 may include additional aspects, such as any single aspect or any combination of aspects described below and/or in connection with one or more other processes described elsewhere herein.

In a first aspect, the control PDU is a MAC control PDU.

In a second aspect, alone or in combination with the first aspect, one of the respective L2 sublayers is a PDCP sublayer.

In a third aspect, alone or in combination with one or more of the first and second aspects, the control PDU indicates a PDCP sequence number of the discarded PDU associated with the PDCP sublayer.

In a fourth aspect, alone or in combination with one or more of the first through third aspects, one of the respective L2 sublayers is an RLC sublayer.

In a fifth aspect, alone or in combination with one or more of the first through fourth aspects, the control PDU indicates an RLC sequence number of the discarded PDU associated with the RLC sublayer.

In a sixth aspect, alone or in combination with one or more of the first through fifth aspects, one of the respective L2 sublayers is a MAC sublayer.

In a seventh aspect, alone or in combination with one or more of the first through sixth aspects, the control PDU indicates one or more of a CC identifier or a HARQ identifier of the discarded PDU associated with the MAC sublayer.

In an eighth aspect, alone or in combination with one or more of the first through seventh aspects, the control PDU indicates one or more of a LCH identifier associated with one or more of the plurality of discarded PDUs, a compressed header associated with one or more of the plurality of discarded PDUs, a bearer identifier associated with one or more of the plurality of discarded PDUs, or a QoS flow identifier associated with one or more of the plurality of discarded PDUs.

In a ninth aspect, alone or in combination with one or more of the first through eighth aspects, the plurality of discarded PDUs is a first plurality of discarded PDUs, the respective L2 sublayers are first respective L2 sublayers, and the common packet is a first common packet, and the control PDU indicates at least one second plurality of discarded PDUs that are associated with second respective L2 sublayers and that are associated with a second common packet that is different than the first common packet.

In a tenth aspect, alone or in combination with one or more of the first through ninth aspects, the control PDU indicates the at least one second plurality of discarded PDUs relative to the first plurality of discarded PDUs.

In an eleventh aspect, alone or in combination with one or more of the first through tenth aspects, the control PDU indicates a discard cause value associated with one or more of the plurality of discarded PDUs.

In a twelfth aspect, alone or in combination with one or more of the first through eleventh aspects, the discard cause value is associated with one or more of a delay bound expiry, a successful transmission associated with a redundant HARQ process or CC, a PSI, or a redundant encoded PDU associated with FEC.

In a thirteenth aspect, alone or in combination with one or more of the first through twelfth aspects, the control PDU configuration indicates a PDCP sequence number gap signaling mechanism.

In a fourteenth aspect, alone or in combination with one or more of the first through thirteenth aspects, the PDCP sequence number gap signaling mechanism is associated with an F1 interface.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with discarded PDU indication.

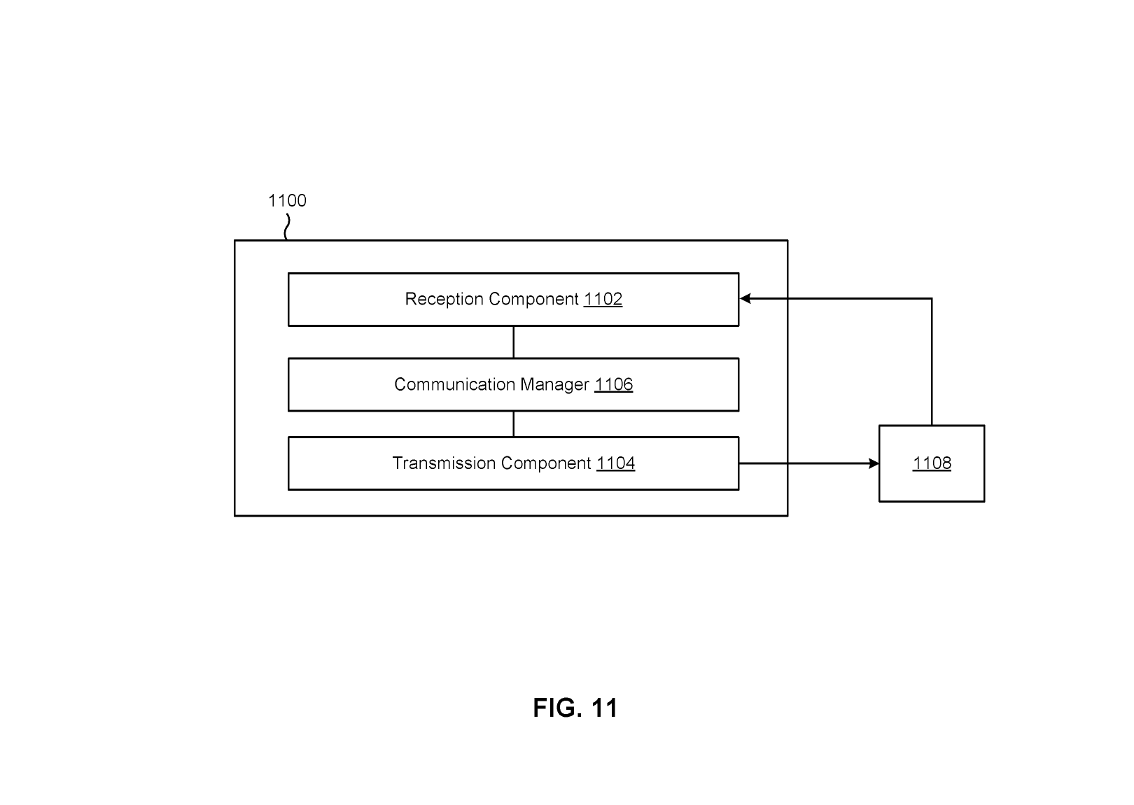

As shown in FIG. 9, in some aspects, process 900 may include transmitting a control PDU configuration (block 910). For example, the network node (e.g., using transmission component 1104 and/or communication manager 1106, depicted in FIG. 11) may transmit a control PDU configuration, as described above. In some aspects, the control PDU configuration may configure the UE to transmit the control PDU and/or when the UE is permitted to transmit the control PDU, as discussed above in connection with reference number 610 (FIG. 6).

As further shown in FIG. 9, in some aspects, process 900 may include receiving, in accordance with the control PDU configuration, a control PDU indicating a plurality of discarded PDUs that are associated with respective L2 sublayers and that are associated with a common packet (block 920). For example, the network node (e.g., using reception component 1102 and/or communication manager 1106, depicted in FIG. 11) may receive, in accordance with the control PDU configuration, a control PDU indicating a plurality of discarded PDUs that are associated with respective L2 sublayers and that are associated with a common packet, as described above. In some aspects, the network node may receive the control PDU based at least in part on the control PDU configuration enabling the UE to transmit the control PDU and/or the control PDU configuration configuring when the UE is permitted to transmit the control PDU, as discussed above in connection with reference number 620 (FIG. 6).

Process 900 may include additional aspects, such as any single aspect or any combination of aspects described below and/or in connection with one or more other processes described elsewhere herein.

In a first aspect, the control PDU is a MAC control PDU.

In a second aspect, alone or in combination with the first aspect, one of the respective L2 sublayers is a PDCP sublayer.

In a third aspect, alone or in combination with one or more of the first and second aspects, the control PDU indicates a PDCP sequence number of the discarded PDU associated with the PDCP sublayer.

In a fourth aspect, alone or in combination with one or more of the first through third aspects, one of the respective L2 sublayers is an RLC sublayer.

In a fifth aspect, alone or in combination with one or more of the first through fourth aspects, the control PDU indicates an RLC sequence number of the discarded PDU associated with the RLC sublayer.

In a sixth aspect, alone or in combination with one or more of the first through fifth aspects, one of the respective L2 sublayers is a MAC sublayer.

In a seventh aspect, alone or in combination with one or more of the first through sixth aspects, the control PDU indicates one or more of a CC identifier or a HARQ identifier of the discarded PDU associated with the MAC sublayer.

In an eighth aspect, alone or in combination with one or more of the first through seventh aspects, the control PDU indicates one or more of a LCH identifier associated with one or more of the plurality of discarded PDUs, a compressed header associated with one or more of the plurality of discarded PDUs, a bearer identifier associated with one or more of the plurality of discarded PDUs, or a QoS flow identifier associated with one or more of the plurality of discarded PDUs.

In a ninth aspect, alone or in combination with one or more of the first through eighth aspects, the plurality of discarded PDUs is a first plurality of discarded PDUs, the respective L2 sublayers are first respective L2 sublayers, and the common packet is a first common packet, and the control PDU indicates at least one second plurality of discarded PDUs associated with second respective L2 sublayers and a second common packet that is different than the first common packet.

In a tenth aspect, alone or in combination with one or more of the first through ninth aspects, the control PDU indicates the at least one second plurality of discarded PDUs relative to the first plurality of discarded PDUs.

In an eleventh aspect, alone or in combination with one or more of the first through tenth aspects, the control PDU indicates a discard cause value associated with one or more of the plurality of discarded PDUs.

In a twelfth aspect, alone or in combination with one or more of the first through eleventh aspects, the discard cause value is associated with one or more of a delay bound expiry, a successful transmission associated with a redundant HARQ process or CC, a PSI, or a redundant encoded PDU associated with FEC.

In a thirteenth aspect, alone or in combination with one or more of the first through twelfth aspects, the control PDU configuration indicates a PDCP sequence number gap signaling mechanism.

In a fourteenth aspect, alone or in combination with one or more of the first through thirteenth aspects, the PDCP sequence number gap signaling mechanism is associated with an F1 interface.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 6 and 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 1 and FIG. 2. Additionally, or alternatively, one or more components shown in FIG. 10 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a control PDU configuration. The transmission component 1004 may transmit, in accordance with the control PDU configuration, a control PDU indicating a plurality of discarded PDUs that are associated with respective L2 sublayers and that are associated with a common packet.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6 and 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit a control PDU configuration. The reception component 1102 may receive, in accordance with the control PDU configuration, a control PDU indicating a plurality of discarded PDUs that are associated with respective L2 sublayers and that are associated with a common packet.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a control protocol data unit (PDU) configuration; and transmitting, in accordance with the control PDU configuration, a control PDU indicating a plurality of discarded PDUs that are associated with respective layer 2 (L2) sublayers and that are associated with a common packet.

Aspect 2: The method of Aspect 1, wherein the control PDU is a medium access control (MAC) control PDU.

Aspect 3: The method of any of Aspects 1-2, wherein one of the respective L2 sublayers is a packet data convergence protocol (PDCP) sublayer.

Aspect 4: The method of Aspect 3, wherein the control PDU indicates a PDCP sequence number of the discarded PDU associated with the PDCP sublayer.

Aspect 5: The method of any of Aspects 1-4, wherein one of the respective L2 sublayers is a radio link control (RLC) sublayer.

Aspect 6: The method of Aspect 5, wherein the control PDU indicates an RLC sequence number of the discarded PDU associated with the RLC sublayer.

Aspect 7: The method of any of Aspects 1-6, wherein one of the respective L2 sublayers is a medium access control (MAC) sublayer.

Aspect 8: The method of Aspect 7, wherein the control PDU indicates one or more of a component carrier (CC) identifier or a hybrid automatic repeat request (HARQ) identifier of the discarded PDU associated with the MAC sublayer.

Aspect 9: The method of any of Aspects 1-8, wherein the control PDU indicates one or more of: a logical channel (LCH) identifier associated with one or more of the plurality of discarded PDUs, a compressed header associated with one or more of the plurality of discarded PDUs, a bearer identifier associated with one or more of the plurality of discarded PDUs, or a quality of service (QoS) flow identifier associated with one or more of the plurality of discarded PDUs.

Aspect 10: The method of any of Aspects 1-9, wherein the plurality of discarded PDUs is a first plurality of discarded PDUs, the respective L2 sublayers are first respective L2 sublayers, and the common packet is a first common packet, and wherein the control PDU indicates at least one second plurality of discarded PDUs that are associated with second respective L2 sublayers and that are associated with a second common packet that is different than the first common packet.

Aspect 11: The method of Aspect 10, wherein the control PDU indicates the at least one second plurality of discarded PDUs relative to the first plurality of discarded PDUs.

Aspect 12: The method of any of Aspects 1-11, wherein the control PDU indicates a discard cause value associated with one or more of the plurality of discarded PDUs.

Aspect 13: The method of Aspect 12, wherein the discard cause value is associated with one or more of: a delay bound expiry, a successful transmission associated with a redundant hybrid automatic repeat request (HARQ) process or component carrier (CC), a PDU set importance (PSI), or a redundant encoded PDU associated with forward error correction (FEC).

Aspect 14: The method of any of Aspects 1-13, wherein the control PDU configuration indicates a packet data convergence protocol (PDCP) sequence number gap signaling mechanism.

Aspect 15: The method of Aspect 14, wherein the PDCP sequence number gap signaling mechanism is associated with an F1 interface.

Aspect 16: A method of wireless communication performed by a network node, comprising: transmitting a control protocol data unit (PDU) configuration; and receiving, in accordance with the control PDU configuration, a control PDU indicating a plurality of discarded PDUs that are associated with respective layer 2 (L2) sublayers and that are associated with a common packet.

Aspect 17: The method of Aspect 16, wherein the control PDU is a medium access control (MAC) control PDU.

Aspect 18: The method of any of Aspects 16-17, wherein one of the respective L2 sublayers is a packet data convergence protocol (PDCP) sublayer.

Aspect 19: The method of Aspect 18, wherein the control PDU indicates a PDCP sequence number of the discarded PDU associated with the PDCP sublayer.

Aspect 20: The method of any of Aspects 16-19, wherein one of the respective L2 sublayers is a radio link control (RLC) sublayer.

Aspect 21: The method of Aspect 20, wherein the control PDU indicates an RLC sequence number of the discarded PDU associated with the RLC sublayer.

Aspect 22: The method of any of Aspects 16-21, wherein one of the respective L2 sublayers is a medium access control (MAC) sublayer.

Aspect 23: The method of Aspect 22, wherein the control PDU indicates one or more of a component carrier (CC) identifier or a hybrid automatic repeat request (HARQ) identifier of the discarded PDU associated with the MAC sublayer.

Aspect 24: The method of any of Aspects 16-23, wherein the control PDU indicates one or more of: a logical channel (LCH) identifier associated with one or more of the plurality of discarded PDUs, a compressed header associated with one or more of the plurality of discarded PDUs, a bearer identifier associated with one or more of the plurality of discarded PDUs, or a quality of service (QoS) flow identifier associated with one or more of the plurality of discarded PDUs.

Aspect 25: The method of any of Aspects 16-24, wherein the plurality of discarded PDUs is a first plurality of discarded PDUs, the respective L2 sublayers are first respective L2 sublayers, and the common packet is a first common packet, and wherein the control PDU indicates at least one second plurality of discarded PDUs associated with second respective L2 sublayers and a second common packet that is different than the first common packet.

Aspect 26: The method of Aspect 25, wherein the control PDU indicates the at least one second plurality of discarded PDUs relative to the first plurality of discarded PDUs.

Aspect 27: The method of any of Aspects 16-26, wherein the control PDU indicates a discard cause value associated with one or more of the plurality of discarded PDUs.

Aspect 28: The method of Aspect 27, wherein the discard cause value is associated with one or more of: a delay bound expiry, a successful transmission associated with a redundant hybrid automatic repeat request (HARQ) process or component carrier (CC), a PDU set importance (PSI), or a redundant encoded PDU associated with forward error correction (FEC).

Aspect 29: The method of any of Aspects 16-28, wherein the control PDU configuration indicates a packet data convergence protocol (PDCP) sequence number gap signaling mechanism.

Aspect 30: The method of Aspect 29, wherein the PDCP sequence number gap signaling mechanism is associated with an F1 interface.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a control protocol data unit (PDU) configuration; and
transmit, in accordance with the control PDU configuration, a control PDU indicating a plurality of discarded PDUs that are associated with respective layer 2 (L2) sublayers and that are associated with a common packet.

2. The apparatus of claim 1, wherein the control PDU is a medium access control (MAC) control PDU.

3. The apparatus of claim 1, wherein one of the respective L2 sublayers is a packet data convergence protocol (PDCP) sublayer.

4. The apparatus of claim 3, wherein the control PDU indicates a PDCP sequence number of the discarded PDU associated with the PDCP sublayer.

5. The apparatus of claim 1, wherein one of the respective L2 sublayers is a radio link control (RLC) sublayer.

6. The apparatus of claim 5, wherein the control PDU indicates an RLC sequence number of the discarded PDU associated with the RLC sublayer.

7. The apparatus of claim 1, wherein one of the respective L2 sublayers is a medium access control (MAC) sublayer.

8. The apparatus of claim 7, wherein the control PDU indicates one or more of a component carrier (CC) identifier or a hybrid automatic repeat request (HARQ) identifier of the discarded PDU associated with the MAC sublayer.

9. The apparatus of claim 1, wherein the control PDU indicates one or more of:
a logical channel (LCH) identifier associated with one or more of the plurality of discarded PDUs,
a compressed header associated with one or more of the plurality of discarded PDUs,
a bearer identifier associated with one or more of the plurality of discarded PDUs, or
a quality of service (QoS) flow identifier associated with one or more of the plurality of discarded PDUs.

10. The apparatus of claim 1, wherein the plurality of discarded PDUs is a first plurality of discarded PDUs, the respective L2 sublayers are first respective L2 sublayers, and the common packet is a first common packet, and wherein the control PDU indicates at least one second plurality of discarded PDUs that are associated with second respective L2 sublayers and that are associated with a second common packet that is different than the first common packet.

11. The apparatus of claim 10, wherein the control PDU indicates the at least one second plurality of discarded PDUs relative to the first plurality of discarded PDUs.

12. The apparatus of claim 1, wherein the control PDU indicates a discard cause value associated with one or more of the plurality of discarded PDUs.

13. The apparatus of claim 12, wherein the discard cause value is associated with one or more of:
a delay bound expiry,
a successful transmission associated with a redundant hybrid automatic repeat request (HARQ) process or component carrier (CC),
a PDU set importance (PSI), or
a redundant encoded PDU associated with forward error correction (FEC).

14. The apparatus of claim 1, wherein the control PDU configuration indicates a packet data convergence protocol (PDCP) sequence number gap signaling mechanism.

15. The apparatus of claim 14, wherein the PDCP sequence number gap signaling mechanism is associated with an F1 interface.

16. A method of wireless communication performed by a user equipment (UE), comprising:
receiving a control protocol data unit (PDU) configuration; and
transmitting, in accordance with the control PDU configuration, a control PDU indicating a plurality of discarded PDUs that are associated with respective layer 2 (L2) sublayers and that are associated with a common packet.

17. The method of claim 16, wherein the control PDU is a medium access control (MAC) control PDU.

18. The method of claim 16, wherein the plurality of discarded PDUs is a first plurality of discarded PDUs, the respective L2 sublayers are first respective L2 sublayers, and the common packet is a first common packet, and wherein the control PDU indicates at least one second plurality of discarded PDUs that are associated with second respective L2 sublayers and that are associated with a second common packet that is different than the first common packet.

19. An apparatus for wireless communication, comprising:
means for receiving a control protocol data unit (PDU) configuration; and
means for transmitting, in accordance with the control PDU configuration, a control PDU indicating a plurality of discarded PDUs that are associated with respective layer 2 (L2) sublayers and that are associated with a common packet.

20. The apparatus of claim 19, wherein the control PDU is a medium access control (MAC) control PDU.
